(19) United States
(12) Patent Application Publication
(10) Pub. No.: US 2011/0276491 A1
(43) Pub. Date: Nov. 10, 2011

(54) METHODS AND SYSTEMS FOR IN-GAME ADVERTISING

(76) Inventors: Douglas Elliott, Chesterfield, MO (US); Kevin Bertel, St. Louis, MO (US); Michael Skolones, St. Louis, MO (US); Paul A. Schneider, St. Louis, MO (US); Timothy R. Smith, Eureka, MO (US); Brian Stamper, Richmond Heights, MO (US)

(21) Appl. No.: 12/982,513

(22) Filed: Dec. 30, 2010

Related U.S. Application Data
(60) Provisional application No. 61/291,672, filed on Dec. 31, 2009.

(51) Int. Cl. G06Q 30/00; H04L 9/28

(52) U.S. Cl. 705/50; 705/14.4

(57) ABSTRACT

Methods and systems for content initiation are described. In one embodiment, execution of an executable application is initiated. The executable application is associated with source code of a gaming application and a compiled version of a gaming application. Advertising data is received through a network. The source code of the gaming application is recompiled using the advertising data to create a recompiled version of the gaming application. Game play of the recompiled version of the gaming application is initiated. The game play includes presentation of advertising based on at least a portion of the advertising data. Additional methods and systems are disclosed.

### CROSS-REFERENCE TO RELATED APPLICATIONS

This application claims the benefit of U.S. Provisional Patent Application entitled “Multiple Platform Gaming System Including, Targeted Advertising Capability”, Ser. No. 61/291,672, filed 31 Dec. 2009 the entire contents of which is herein incorporated by reference.

### FIELD

This application relates to methods and systems for advertising, and more specifically to methods and systems for in-game advertising.

### BACKGROUND

Conventional broadcast advertising commercial deployment is often based on agreements between a client that wants its message to be broadcast for any number of reasons by an entity that controls some or of all of aspects of a broadcast capability and a broadcaster wherein a client advertiser is an entity that is paying to have the entity's message or product information or service information made available to broadcast television viewers. Additionally, it is not uncommon for agreements between client and broadcaster wherein the broadcaster will electronically broadcast specific, pre-produced, full length (60 second or shorter) commercials at specific times or broadcast the content for a specific number of times.

Electronic games are created for a broad range of electronic gaming platforms, such as personal computers in a wide range of configurations, proprietary video game consoles, coin operated arcade machines, mobile game devices, mobile telephones, and the like. Many electronic games are designed exclusively for a particular gaming platform, and may be compatible with one or more, but not typically all, gaming platforms. For example, a particular game may be available for use on a stand alone personal computer, a personal computer connected to the Internet, and a mobile telephone, but no version of the game exists for any proprietary game consoles. Moreover, when a multiple player game does exist for multiple platforms, it is very rare that players on dissimilar gaming platforms can share a game session or compete across gaming platforms. In addition, many popular gaming platforms have limited, if any, capability to access the Internet. As a result, electronic games are segmented and isolate players from each other because of incompatible gaming platforms.

Because of the segmentation of electronic games associated with limited internet access capability of many gaming platforms and the inability to share game sessions across gaming platforms, electronic games may not be considered desirable to advertisers.

### BRIEF DESCRIPTION OF THE DRAWINGS

FIGS. 1 and 2 are block diagrams of example systems, according to example embodiments;

FIG. 3 is a block diagram of an example player device that may be deployed within the system of FIG. 1 or FIG. 2, according to an example embodiment;

FIG. 4 is a block diagram of an example central gaming device that may be deployed within the system of FIG. 1 or FIG. 2, according to an example embodiment;

FIG. 5 is a block diagram of a gaming subsystem that may be deployed within the player device of FIG. 3 or the central gaming device of FIG. 4, according to an example embodiment;

FIGS. 6-9 are block diagrams of flowcharts illustrating methods for in-game advertising, according to example embodiments; and

FIG. 10 is a block diagram of a machine in the example form of a computer system within which a set of instructions for causing the machine to perform any one or more of the methodologies discussed herein may be executed.

### DETAILED DESCRIPTION

Example methods and systems for in-game advertising are described. In the following description, for purposes of explanation, numerous specific details are set forth in order to provide a thorough understanding of example embodiments. It will be evident, however, to one of ordinary skill in the art that embodiments of the invention may be practiced without these specific details.

The methods and systems enable game play with in-game advertising. The in-game advertising is part of the game itself, in that the game when compiled has the advertising as part of the game play. For example, billboards, shirts on characters, or decorations on cars that, when including advertising, are examples of in-game advertising. The compilation of the source code with the advertising data may enable the game play of the game to be more seamless and without lag. In some embodiments, the compilation of the source code with the advertising data may be more reduce the likelihood of advertising tampering for the game while still allowing dynamic changes to the in-game advertising. In some embodiments, the methods and systems allow for regional distribution and configuration of the game and associated in-game advertisements presented during game play.

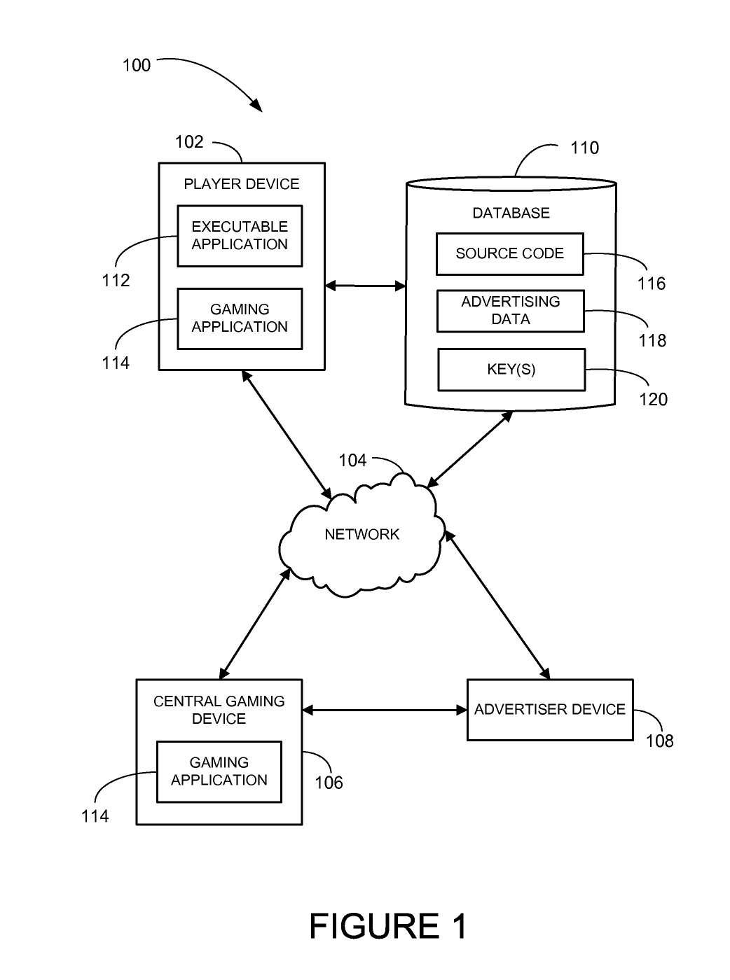

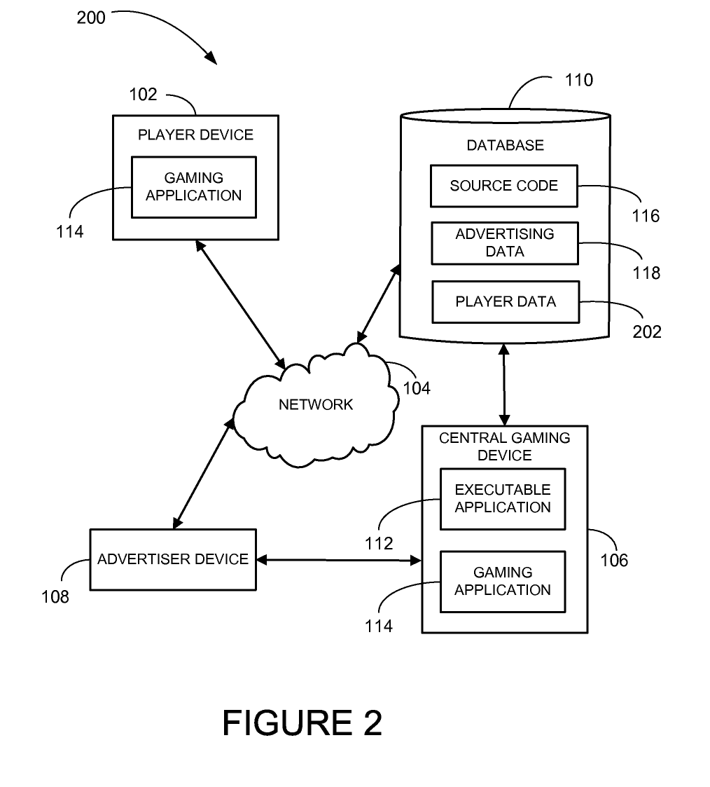

FIGS. 1 and 2 illustrate example systems 100, 200 in which in-game advertising may be performed. The systems 100, 200 are example platforms in which one or more embodiments of the methods may be used. However, the in-game advertising may also be performed on other platforms.

A player may operate a player device 102 to participate in game play. The player device 102 may be a personal computer, a mobile electronic device (e.g., a mobile phone), a portable or fixed gaming unit, or the like. Other types of devices with which a player may play with a game may also be player devices 102.

The player device 102 may be a stand alone device, or may operate over a network 104 in conjunction with a central gaming device 106. The network 104 over which the player device 102 and the central gaming device 106 may communicate include, by way of example, a Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

In general, the central gaming device 106 is a device operated by a gaming company to enable players to participate in a game. The central gaming device 106 may be limited to simply providing source code to the player device 102 for compilation, the central gaming device 106 may provide at least some of the gaming functionality during game play, or the player may user the player device 102 to interface with the gaming functionality in operation on central gaming device 106. Other configurations of the systems 100, 200 may include the player device 102 and the central gaming device 106 having differing amounts and/or types of functionality.

The central gaming device 106 may provide core services including, but not limited, to management of user accounts, distributor accounts, billing and accounting, advertising, report generation, and game sessions.

The advertising device 108 may be in communication with the player device 102 and/or the central gaming device to provide advertising data 118 that may be used for in-game advertising.

In some embodiments, the advertiser associated with the advertiser device 108 may distribute a gaming application 114 (and/or the executable application 112) to the player device 102. The gaming application 114 enables electronic game play of a game by a single player or multiple players through use of a compiled version of the source code of the game. In some embodiments, the gaming application 114 may be a thick client, a thin client, or a different type of client when operating on the player device 102.

There may be multiple advertisers for a game, or a single advertising for a game. The advertiser and the gaming operator associated with the central gaming device may be the same entity, may be associated with one another, may have a loose relationship with one another, or may be unknown to the other party.

The central gaming device 106 and the advertising device 108 may be separate devices or combined into a single device in the systems 100, 200. The central gaming device 106 may be in a networked relationship with the advertising device 108, in a client-server relationship with the advertising device 108, a peer-to-peer relationship with the advertising device 108, or in a different type of relationship with the advertising device 108.

In one embodiment, the central gaming device 106 is a single device. In one embodiment, the central gaming device 106 may include multiple devices. For example, the central gaming device 106 may include multiple computer systems in a cloud computing configuration. The advertising device 108 may be similarly deployed as a single device or multiple devices in the system 100.

An executable application 112 and/or a gaming application 114 may be deployed within the player device 102, the central gaming device 106, or both devices 102, 106. The executable application 112 enables in-game advertising to occur during game play. The executable application 112 does not operate the game, but rather produces a compiled version of the gaming application 114 that includes in-game advertising. Thus, the executable application 112 generally facilitates compilation or recompilation of source code 116. The executable application 112 may compile or recompile the source code 116, or may cause a different application to compile or recompile the source code 116. According, a compiler may be internal or external to the executable application 112.

The player device 102 may communicate with a database 110. The database 110 may include the source code 116, the advertising data 118, keys 120, and/or the player data 202.

The source code 116 is associated with the gaming application 114 and, when compiled or recompiled, enables the player to participate in game play.

The advertising data 118 includes data used to generate in-game advertisements. The advertising data 118 may include images, video, text, and the like.

The keys 120 may include source code keys, advertising data keys, or the like. The source code keys may be used to decrypt source code. The advertising data keys may be used to decrypt advertising data.

The gaming application 114 may be limited to a single game or may be associated with multiple games. In some embodiments, the gaming application 114 is part of a multiple platform game system having at least one game.

The player data 202 may be used to track information about players. The player data 202 may include registration data, player profile data, or the like.

As shown in the system 200, the executable application 112 is deployed on the central gaming device 106 instead of the player device 102 as in the system 100. Thus, while the game play still occurs for the user through the player device 102, the functionality of the executable application is incorporated in the central gaming device 106.

In some embodiments, the systems 100, 200 connects players for an effective game sharing experience across dramatically different gaming platforms by implementing gaming platform specific applications or games that communicate to the central gaming device 106 through device appropriate protocols. Thus, players may share a game session or compete with one another using dissimilar gaming platforms including, but not limited to, high performance, gaming quality, personal computers, equipped with powerful graphics cards, sound processors, and other equipment required to run advanced 3D graphics and simulation; low end, office quality computers without advanced graphics support; high performance cellular telephones equipped with internet browsing and graphics capabilities; low end cellular telephones equipped with SMS text messaging functionality; televisions equipped with high performance set top boxes, and the like. These platforms may be deployed on, included with, or otherwise be at least apart of the player device 102.

While the systems 100, 200 displayed in FIGS. 1 and 2 reflect a single player device, a single central gaming device, and a single advertiser device, multiple player devices, multiple central gaming devices, and/or multiple advertiser devices may be deployed in the systems 100, 200.

The systems 100, 200 include a flexible advertising capability that allows updates to advertising that is displayed in-game. In some embodiments, the systems 100, 200 allow targeted advertising based on advertising related criteria such as geographic region, player demographics, or the like. Thus, different in-game advertising may be displayed to different players playing the same game in different sessions.

Game sessions of the systems 100, 200 may be shared across several platforms, including both low performance and high performance personal computers, high performance mobile telephones equipped with internet browsing capability, low cost mobile telephones equipped with text messaging, and advanced set top box appliances for television receivers, and the like.

Players may, in some embodiments, join a game session regardless of which platform they use to access the system. For example a first player may participate at a computer having high end three dimensional (3D) graphics, a second player may use a web browser on a personal computer, a third player may access the game through a web browser on a mobile telephone, a fourth player may participate through use of a television set top box, and a fifth player may use an SMS text messaging capability of a mobile telephones.

In some embodiments, a targeted regional advertising feature and a global competition with regional prize marketing feature may form a connection between the people who sell the game, the players that play the game, and the advertisers that place advertisements in the game. For example, a licensed game distributor makes a contract with the proprietor of a local restaurant, under which the restaurant agrees to promote the game through coupons, banners and other materials. In return, the licensed distributor agrees to promote the restaurant by placing advertisements in the game. Players joining the game by responding to the coupon will view advertisements for the restaurant within the game. Prizes, such as promotional coupons for the restaurant, or the like are provided to the winner, thus closing advertising the loop.

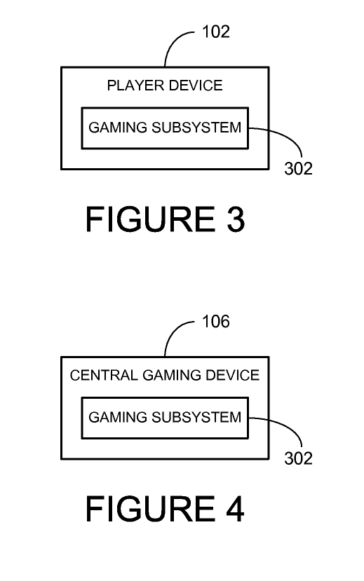

FIG. 3 illustrates an example player device 102 that may be deployed in the system 100 (see FIG. 1), or otherwise deployed in another system. The player device 102 is shown to include the gaming subsystem 302. The gaming subsystem 302 enables game play that includes in-gaming advertising. The gaming subsystem 302 may include functionality of the executable application 112, the gaming application 114, or both the executable application 112 and the gaming application 114.

FIG. 4 illustrates an example central gaming device 106 that may be deployed in the system 100 (see FIG. 1), or otherwise deployed in another system. The central gaming device is shown to include the gaming subsystem 302 (see FIG. 3).

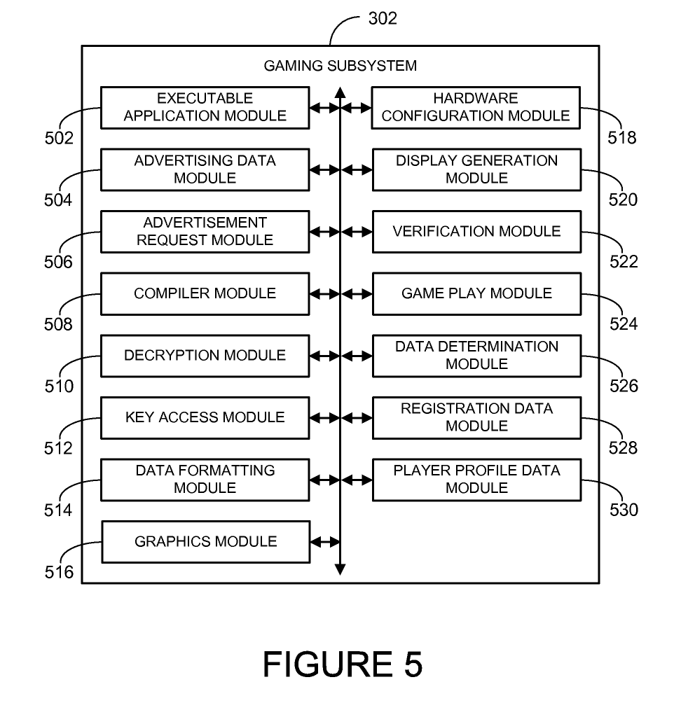

FIG. 5 illustrates an example gaming subsystem 302 that may be deployed in the player device 102, the central gaming device 106, or otherwise deployed in another device. One or more modules are included in the player subsystem 302 to enable game play that includes in-game advertising. The modules of the gaming subsystem 302 that may be included are an executable application module 502, an advertising data module 504, an advertisement request module 506, a compiler module 508, a decryption module 510, a key access module 512, a data formatting module 514, a graphics module 516, a hardware configuration module 518, a display generation module 520, a verification module 522, a game play module 524, a data determination module 526, a registration data module 528, and/or a player profile data module 530. Other modules may also be included. In various embodiments, the modules may be distributed so that some of the modules may be deployed in the player device 102 and some of the modules may be deployed in the central gaming device 106. In one particular embodiment, the gaming subsystem 202 includes a processor, memory coupled to the processor, and a number of the aforementioned modules deployed in the memory and executed by the processor.

The executable application module 502 initiates execution of the executable application 112 (see FIG. 1). Through initiation, the executable application 112 operates on the player device 102, the central gaming device 106, or another device. The executable application 112 may be initiated a single time and then may operate for an extended period of time (e.g., over multiple gaming sessions). The executable application 112 may be initiated immediately prior to a game play session, in anticipation of a game play session, or the like.

The advertising data module 504 receives the advertising data 118 through the network 104. The advertising data 118 may be received from the central gaming device 106, the advertiser device 108, both devices 106, 108, or from another device. When received, the advertising data module 504 may store the advertising data 118 in the database 110. The advertising data 118 as stored in the database 110 may be received in a single transmission or through multiple transmissions (e.g., over a period of time and/or from multiple devices).

In some embodiments, the advertisement request module 506 transmits an advertisement request. The advertising data 118 may then be received in response to transmission of the advertisement request. In some embodiments, the advertising data 118 may be provided periodically without advertisement requests being sent.

The compiler module 508 recompiles the source code of the gaming application 114 using the advertising data 118 to create a recompiled version of the gaming application 114. Once the source code is recompiled, the player may play a game associated with the recompiled version of the gaming application 114 and view the in-game advertising.

Recompiling the source code by the compiler module 508 may include altering the source code of the gaming application 114 to include the advertising data 118 and compiling the altered source code to create the recompiled version of the gaming application 114 that includes the in-game advertising as part of the game play. The source code may be altered by modifying a single source code programming line of source code or multiple source code programming lines of source code to include the advertising data 118. To make the appropriate modifications, the source code programming lines may be identified for inclusion of the advertising data 118.

When the source code is encrypted, the decryption module 510 decrypts the source code to obtain decrypted source code. The compiler module 508 then recompiles the decrypted source code.

In some embodiments, the key access module 512 accesses a source code key associated with the executable application 112. The source code may then be decrypted by the decryption module 510 using the source code key to obtain the decrypted source code and/or the advertising data key. In one embodiment, the compiler module 508 may then recompile the decrypted source code. In another embodiment, the advertising data 118 may then be decrypted using the advertising data key to obtain decrypted advertising data. The source code of the gaming application 114 may then be recompiled using the decrypted advertising data to create the recompiled version of the gaming application 114.

The advertising data 118 may be used by the compiler module 508 without further modification or the advertising data 118 may be modified prior to completion of the recompilation. For example, the data formatting module 514 may be used to format the advertising data for the gaming application to create formatted advertising data. The recompilation of the source code by the compiler module 508 then uses the formatted advertising data to create the recompiled version of the gaming application. The graphics module 516 may be used to generate graphics for the gaming application based on the advertising data. The recompilation of the source code by the compiler module 508 then uses the graphics to create the recompiled version of the gaming application 114. The advertising data 118 may otherwise be modified prior to completion of the recompilation.

The advertising data 118 may be used by the graphics module 516 to modify graphics associated with the gaming application 114 based on the advertising data 118. The recompilation of the source code by the compiler module 508 then uses the modified graphics to create the recompiled version of the gaming application 114.

In some embodiments, the hardware configuration module 518 identifies a hardware configuration (e.g., of the player device 102 or the central gaming device 106). The source code may then be recompiled based on identification of the hardware configuration.

The display generation module 520 may be used to generate a display including a game sequence during recompilation of the source code. The display may be a user interface, a programmable interface, or the like.

In some embodiments, the verification module 522 may determine whether the recompilation of the source code was successful. For example, if the verification module 522 determines that a compiler error has occurred, the verification module 522 may determine that the recompilation of the source code was unsuccessful.

The verification module 522 verifies the recompiled version of the gaming application 114. The verification may include determining that the gaming application 114 runs as intended (e.g., without errors)

The game play module 524 initiates game play of the recompiled version of the gaming application 114. The game play includes in-game presentation of advertising based on at least a portion of the advertising data 118. In some embodiments, game play may be initiated only when the verification module 522 verifies the recompiled version of the gaming application 114.

As described above, the gaming subsystem 302 may be deployed in the player device 102, in the central gaming device 106, or both in the player device 102 and the central gaming device 106 with the same or different functionality.

In an implementation of the gaming subsystem 302, the data determination module 526 may be included to determine whether the advertising data 118 meets an advertising criterion associated with a player of the gaming application 114. Initiation of the game play of the recompiled version of the gaming application 114 for the player of the gaming application 114 may then be made when the advertising criterion is met.

Multiple game players may interact with the central gaming device 106. These game players may participate simultaneously (or nearly simultaneously) with their respective gaming applications 114. Depending on the game, the players may make gaming interactions with one another during game play.

For example, the advertising data module 504 receives additional advertising data through the network 104, the data determination module 526 determines that the additional advertising data meets the advertising criterion associated with an additional player of the gaming application 114, the compiler module 508 recompiles the source code of the gaming application 114 using the additional advertising data to create an additional recompiled version of the gaming application, and the game play module 524 initiates game play of the additional recompiled version of the gaming application 114 for the additional play that includes presentation of advertising based on at least a portion of the additional advertising data 118.

During game play by the player, the game play module 524 operates the gaming application 114 to enable a player to engage in the game play. The game play module 524 may credit an account associated with the player based on the player's engagement in the game play including the presentation of the advertising. For example, credit may be provided to the play for each advertisement viewed during the course of game play.

The advertising presented to the players may differ. For example, the registration data module 528 may be used to access registration data associated with a player of the gaming application and the advertising data module 504 may select the advertising data 118 from available advertising data based on the registration data. The advertising presented to the player may then be based on the selection of the advertising data 118.

The differing advertising may be also be presented by the player profile data module 532 accessing player profile data associated with a player of the gaming application and the advertising data module 504 selecting the advertising data 118 from available advertising data based on the player profile data. Initiation of the game play of the recompiled version of the gaming application 114 by the game play module 524 is then based on selection of the advertising data 118.

In another implementation of the gaming subsystem 302, the compiler module 508 compiles at least a first portion of source code of the gaming application 114 using the advertising data 118 to create an executable file associated the gaming application 114, the game play module 524 enables game play of the gaming application 114 including presentation of advertising based on at least a portion of the advertising data 118 using the executable file, the advertising data module 504 receives additional advertising data through the network 104, the compiler module 508 compiling at least a second portion of the source code of the gaming application 114 using the additional advertising data to create an additional executable file and the game play module 524 enabling further game play of the gaming application 114 including presentation of additional advertising based on at least a portion of the additional advertising data using the additional executable file.

The switch between the executable file and the additional executable file may occur due to a number of different reasons. For example, the advertising data module 504 may be used to determine whether additional advertising data has been received during game play. When received, the compiler module 508 may then compile the second portion of the source code. In another example, the compiler module 508 may determine whether a recompilation point has been reached during the game play. When the recompilation point is reached, the compiler module 508 then compiles at least the second portion of the source code of the gaming application.

The compiling of the second portion of the source code may occur dynamically during game play.

In another implementation of the gaming subsystem 302, the executable application module 502 initiates execution of the executable application 112. The key access module 512 accesses a source code key associated with the executable application 112. The decryption module 510 decrypts the source code to obtain decrypted source code and an advertising data key. The verification module 522 then determines whether available advertising data associated with the gaming application 114 is valid by use of the advertising data key. When the advertising data is valid, the compiler module 508 may compile or recompile the source code. When the advertising data is not valid, the compiler module 508 may not compile or recompile the source code.

The advertising data module 504 may then receive replacement advertising data through the network 104. The compiler module 508 recompiles the source code of the gaming application 114 using the replacement advertising data to create a recompiled version of the gaming application 114. Prior to recompilation, the verification module 522 may determine whether the additional advertising data is valid by use of the advertising data key.

After recompilation, game play of the recompiled version of the gaming application 114 may be initiated by the executable application module 502.

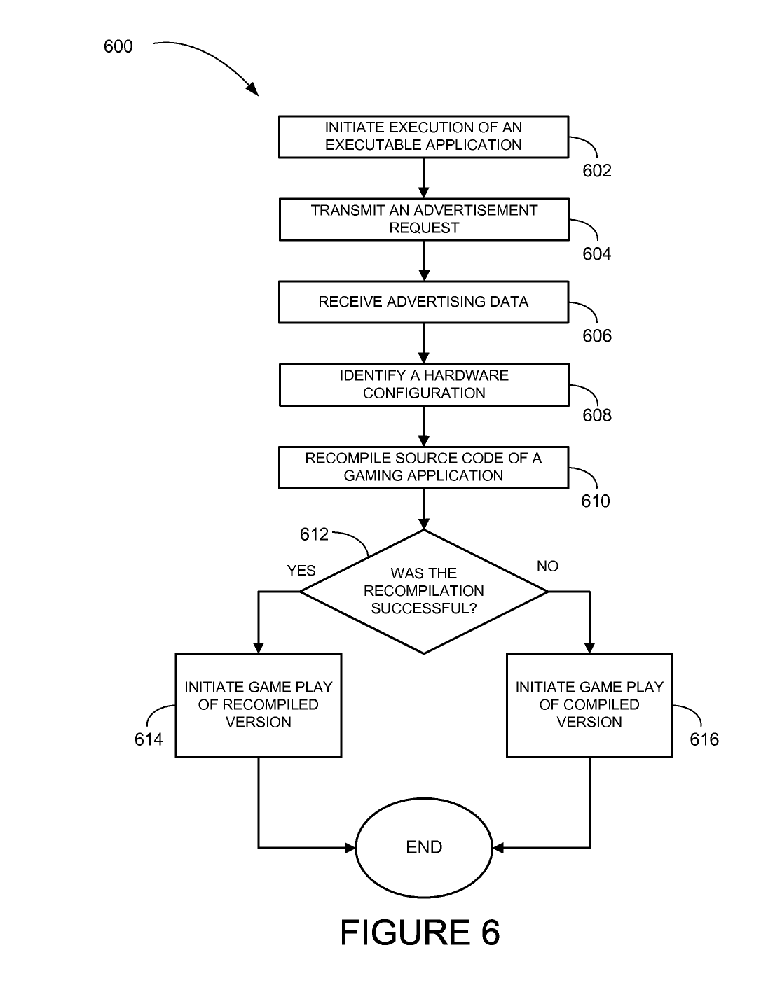

FIG. 6 illustrates a method 600 for in-game advertising according to an example embodiment. The method 600 may be performed by the player device 102 and/or the central gaming device 106 of the systems 100, 200 (see FIGS. 1 and 2), or may be otherwise performed.

Execution of the executable application 112 is initiated at block 602. The executable application 112 is associated with source code of the gaming application 114 and a compiled version of the gaming application 114.

An advertisement request may be transmitted at block 604. Advertising data is received through the network 104 at block 606. The advertising data 118 may be received from the advertiser device 108 and/or the central gaming device 114. The advertising data 118 may be received in response to the advertising request, may be received periodically without request, or may otherwise be received. In some embodiments, the received advertising data may be formatted for compilation.

A hardware configuration may be identified at block 608.

The source code of the gaming application 114 is recompiled at block 610 using the advertising data 118 to create a recompiled version of the gaming application 114. A display including a game sequence may be generated during recompilation of the source code.

Recompiling the source code may include altering the source code of the gaming application 114 to include the advertising data 118 and compiling the altered source code to create the recompiled version of the gaming application 114. Altering the source code may include modifying a single source code programming line of source code or multiple source code programming line to include the advertising data 118. These source code lines may be identified for inclusion of the advertising data 118.

In some embodiments, graphics for the gaming application 114 are generated based on the advertising data. In some embodiments, graphics associated with the gaming application 114 are modified based on the advertising data 118. The generated and/or modified graphics may then be used to create the recompiled version of the gaming application 114.

In some embodiments, the recompilation of the source code is based on identification of the hardware configuration.

In some embodiments, the source code may be decrypted to obtain the decrypted source code and the recompilation of source code of the gaming application 114 is based on decryption of the source code. The source code may be decrypted by accessing a source code key associated with the executable application 112 and decrypting the source code using the source code key.

In some embodiments, decrypting the source code obtains the decrypted source code and an advertising data key. The advertising data may then be decrypted using the advertising data key to obtain decrypted advertising data. The decrypted advertising data may then be used during recompilation.

At decision block 612, a determination may be made as to whether the recompilation was successful. For example, if the recompiled version of the gaming application 114 is verified the recompilation may be deemed successful. If the compilation was successful, then game play of the recompiled version of the gaming application 114 is initiated at block 614. The game play includes presentation of in-game advertising based on at least a portion of the advertising data. The advertising may be part of the image skin of the gaming application. The in-game advertising may include a single image or multiple images presented during the game play. If the compilation was not successful, the compiled version of the gaming application is initiated at block 616.

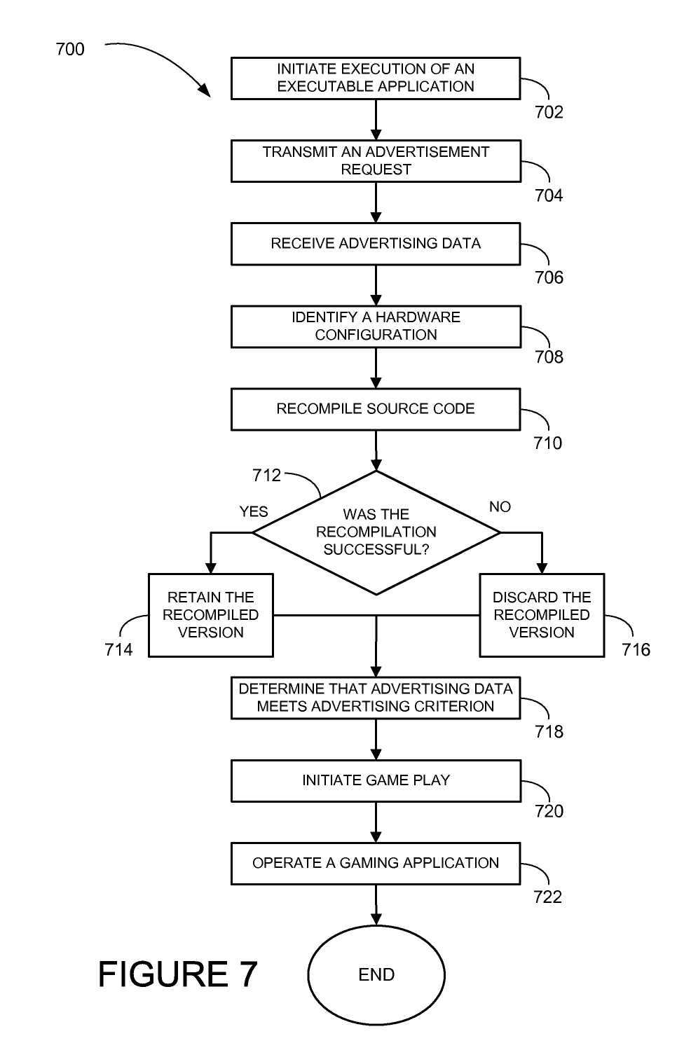

FIG. 7 illustrates a method 700 for in-game advertising according to an example embodiment. The method 700 may be performed by the player device 102 and/or the central gaming device 106 of the systems 100, 200 (see FIGS. 1 and 2), or may be otherwise performed.

Execution of the executable application 112 is initiated at block 702. The executable application 112 is associated with source code of the gaming application 114 and a compiled version of the gaming application 114.

An advertisement request may be transmitted at block 704. Advertising data is received through the network 104 at block 706. The advertising data may be received in response to the advertising request, may be received periodically without request, or may otherwise be received. In some embodiments, the received advertising data may be formatted for compilation.

A hardware configuration may be identified at block 708.

The source code of the gaming application 114 is recompiled at block 710 using the advertising data 118 to create a recompiled version of the gaming application 114. A display including a game sequence may be generated during recompilation of the source code.

At decision block 712, a determination may be made as to whether the recompilation was successful. For example, if the recompiled version of the gaming application is verified the recompilation may be deemed successful.

If the compilation was successful, then the recompiled version of the gaming application 114 is retained at block 714. The game play includes presentation of in-game advertising based on at least a portion of the advertising data. If the compilation was not successful, the recompiled version of the gaming application 114 is discarded at block 716.

A determination that the advertising data 118 meets an advertising criterion associated with a player of the gaming application 114 is made at decision block 718. Initiation of the game play of the recompiled version of the gaming application 114 for the player of the gaming application 114 is then made at block 720. The advertising criterion may be based on registration data associated with the player, player profile data associated with the player, or the like.

Initiation of the game play of the recompiled version of the gaming application 114 may be made for other players that meet the same advertising criterion. Different compiled versions of the gaming application 114 may be used for players that meet different advertising criterion.

The gaming application 114 may be operated to enable a player to engage in the game play at block 722.

An account associated with the player may be credited based on the player's engagement in the game play include the presentation of the advertising.

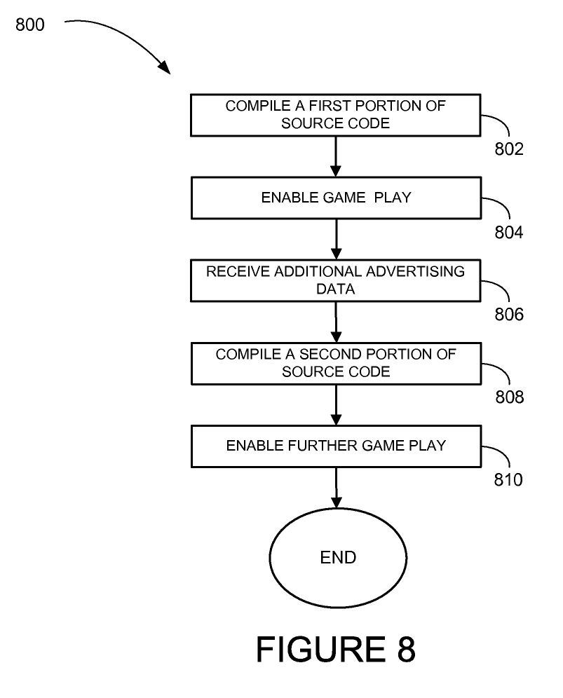

FIG. 8 illustrates a method 800 for in-game advertising according to an example embodiment. The method 800 may be performed by the player device 102 and/or the central gaming device 106 of the systems 100, 200 (see FIGS. 1 and 2), or may be otherwise performed.

At least a first portion of source code of the gaming application 114 is compiled at block 802 using the advertising data 118 to create an executable file associated the gaming application 114.

Game play of the gaming application 114 is enabled at block 804 using the executable file. The game play includes presentation of in-game advertising based on at least a portion of the advertising data.

At block 806, additional advertising data is received through the network 104.

At least a second portion of the source code of the gaming application is compiled at block 808 using the additional advertising data to create an additional executable file. In some embodiments, the compiling of at least the second portion of the source code occurs dynamically during game play.

In some embodiments, a determination that the additional advertising data has been received during the game play is made. Compilation of at least the second portion of source code is then made in response to a determination that the additional advertising data has been received.

In some embodiments, a determination that a recompilation point has been reached during the game play is made. Compiling at least the second portion of the source code of the gaming application is then made in response to a determination that the recompilation point has been reached.

Further game play of the gaming application 114 is enabled at block 810 using the additional executable file. The further game play includes presentation of additional advertising based on at least a portion of the additional advertising data.

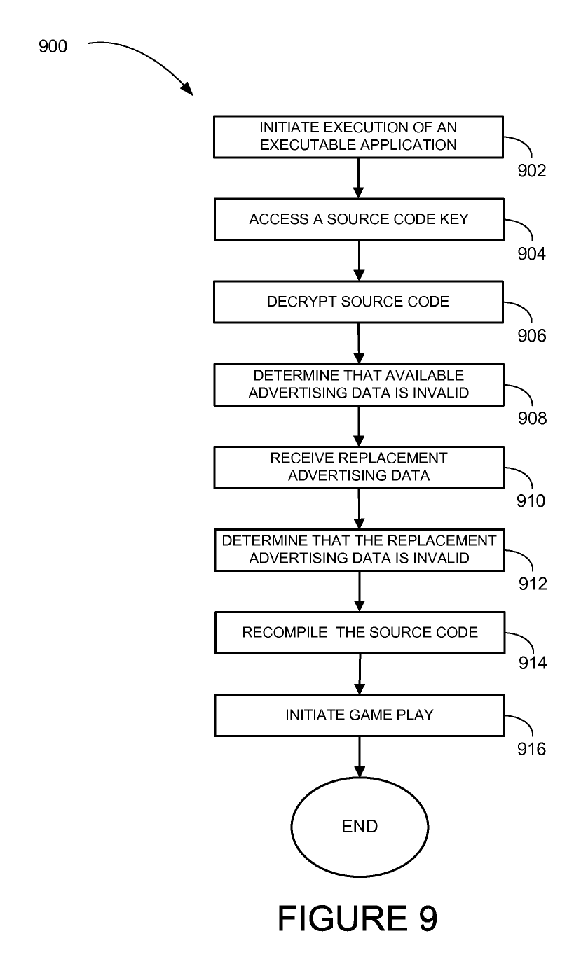

FIG. 9 illustrates a method 900 for in-game advertising according to an example embodiment. The method 900 may be performed by the player device 102 and/or the central gaming device 106 of the systems 100, 200 (see FIGS. 1 and 2), or may be otherwise performed.

Execution of the executable application 112 is initiated at block 902. The executable application 112 is associated with source code of the gaming application 114 and a compiled version of the gaming application 114.

A source code key associated with the executable application 112 is accessed at block 904.

The source code is decrypted at block 906 to obtain decrypted source code and an advertising data key.

At block 908, a determination that available advertising data associated with the gaming application 114 is not valid by use of the advertising data key is made.

Replacement advertising data is received through the network 104 at block 910.

At block 912, a determination that the replacement advertising data associated with the gaming application 114 is valid by use of the advertising data key may be made.

The source code of the gaming application 114 is recompiled at block 914 using the replacement advertising data to create a recompiled version of the gaming application 114.

Game play of the recompiled version of the gaming application 114 is initiated at block 916. The game play includes presentation of advertising based on at least a portion of the advertising data 118.

An example game that the gaming application 114 (see FIG. 1) may implement is a betting game known as Liar's Poker. Despite its name, Liar's Poker is a game of numbers that has little in common with the card game of Poker. A typical game session involves two to five people. Each player holds a dollar bill such that the serial numbers are hidden from the other players. The object of the game is to guess the largest count of identical digits present in the collection of serial numbers. Each player takes a turn at bidding, in fixed order such as ‘around the table clockwise’.

For example, three people are playing, and the first bidder looks at his serial number and notices two ‘3’ digits; he estimates that at least one of the other two players will have a ‘3’, and places the bid: “I say we have three 3's.” The second player must either place a bid that is ‘greater’ than three 3's, e.g. at least four of any digit, or he must call the previous bidder a liar. The next player must either place a bid, or call the bidder a liar as well. The game proceeds until all players other than the bidder have called the bidder a liar, whereupon each player reveals the serial number on their dollar bill to all the players. If the final bidder's guess was incorrect, then he is indeed a liar, and the remaining players each collect a dollar each from the liar. If the final bidder is correct, and therefore is not a liar, he collects a dollar from each player. Many variations of the game are possible, including side bets, elimination tournaments, playing with purpose built cards instead of dollar bills, and the like.

A set of rules for Liar's Poker may include the following:

Liar's Poker is played using randomly picked currency from a wallet. The denomination does not matter. Hoarding ringers is strictly not allowed.

All players agree on the stakes. For example, $1 per person per round. A player does not have to use the exact bill that is being played for. For example, a player can use a $20 bill although playing for only $1. A rule may be set for who goes first. For example, the player whose letter in the serial number is lowest or who won the last time may go first.

A hierarchy of numerals may be established. For example, a hierarchy may be where zeros are low and nines are high.

Players in turn bid on the combined numbers in all serial numbers, including the player whose turn it is and those of the other players. Each player must in turn either declare a higher hand than the previous player or challenge.

In a 3+ player game, all players must challenge to end the game. At this point, the combined serial numbers will be used to determine if the last hand called exists. For example, if the challenged hand is four eights then there must be at least four eights on all serial numbers. If players trust each other, than can simply declare how many of the given number they have. Of course, the challenged player reserves the right to see the bills if he so requests.

If the serial numbers support the bid of the challenged player, then the player will win the agreed upon stakes from each other player. Otherwise the challenged player must pay each other player the agreed upon stakes.

An example set of game bids from three players having bills with noted serial numbers and playing for $1 stakes follows:
Player 1: 2 zeros
Player 2: 2 fives
Player 3: 3 zeros
Player 1: 3 eights
Player 2: 3 nines
Player 3: 4 zeros
Player 1: 5 zeros
Player 2: challenge
Player 3: 6 zeros
Player 1: challenge
Player 2: challenge

Serial Numbers: Player 1: 06742088; Player 2: 92859819; Player 3: 07202503

At this point, the combined serial numbers of the three players must include 6 zeros for Player 3 to win. Combined, there are only 5 zeros in the serial numbers so Player 3 must play $1 each to Players 1 and 2. Had Player 2 had a zero, then Player 3 would have won $1 each from Players 1 and 2.

A version of the foregoing implementation of Liar's Poker may be implemented on the system 200. This version of the gaming application 112 is well suited to the system 200 because the numbers based game play lends itself well to all platforms supported by the systems 100, 200, 3D graphics implementations on high performance personal computers, to implementations based on web browsers, as well as to versions based on SMS text messaging on mobile telephones.

Multiple players across multiple gaming platforms or player devices 102 may join in a game session. Once the game session begins, serial numbers are randomly assigned (e.g., by the central gaming device 106) to simulate a serial number on a dollar bill. Other suitable symbols sets may also be generated and used in place of numbers. Each player bids or challenges based on their random assignment when prompted (e.g., by the gaming application 114). In some embodiments, the players may be participating from different gaming platforms, in different locations, and viewing different targeted advertisements or promotions also provided by the system 200. Once all players have challenged the bidding player, the game declares a winner and updates player scores accordingly. Prizes may also be awarded to a winning player based on the targeted marketing.

Additional features of the game application are available and explained by example in relation to the Liar's Poker gaming application. In certain game sessions, players will have the option to request a new random serial number, symbol set or hand, before the session starts. This feature is similar to allowing a player to choose, for example, from three $1 bills. In some embodiments, mathematical odds related to the truth of one or more bids or possible bids may be computed and displayed to one or more players. As indicated, the randomly generated serial number may be generalized from numbers, to general sets of symbols. For example, the serial number randomly assigned to the player may include letters, shapes or other symbols. In some embodiments, the gaming application 114 may assign a symbol as wild. For example, if 7 is wild and a player is assigned the number 12345678, he or she may choose to substitute a numeral 8 for the numeral 7 and bid accordingly.

In some embodiments, the gaming application may be distributed in such a manner to allow global, national, regional, and local business of any size to effectively advertise to game players within their targeted business territory, even though the players are sharing a game session or competing against each other globally. In doing so, the game system administrator or manager contracts with independent agents to distribute one or more game applications through local channels. For example, a local car dealer or pizza parlor can give away copies of the game application as a promotional item, or a charity or retail store can sell copies for fundraising or commercial purposes. When the player obtains the game application from a distributor, and then installs the game and establishes an online user or player account, the game system server records the association between the player and the distributor by reading an activation code, or through an equivalent mechanism specific to the game platform. Advertising, based on this association is then displayed during game play.

In some embodiments, independent distributors may configure in-game advertising to target players to whom they distributed the game. When the distributor provides updated advertisements to the system server, players associated with that advertiser, based on the information recorded in their user or player account, receive downloads of the updated advertisements during subsequent game sessions. This enables the distributor to sell in game advertising space to local businesses in his or her territory, and guarantee to the advertiser that local players will view the ads. The number of players and/or hours spent viewing each advertisement may then be tracked to allow the distributor to price the advertising service more effectively.

For example, a game system administrator or manager may execute license agreements for one or more game applications with distributors in the San Francisco and Chicago areas. Each set of distributors sells advertising space in the game application, and game players see only those advertisements provided by the advertisers operating in their own localities. While geography has been used to differentiate advertising, other advertising related criteria, including, but not limited to, demographics of players, nationwide advertising, charitable solicitations, community interest messages, and the like may be used.

Another form of advertising includes offers of prizes as an inducement to try to game. This type of advertising is particularly attractive for free or low cost web based games that derive the majority of their revenue from advertising.

In some embodiments, players share game sessions or compete with players globally, while receiving prizes provided by local advertisers based on association in the user or player profile regardless of the gaming platform on which the game is played.

In some embodiments, functionality may be included to prevent cheating, particularly desirable in situations such as high stakes tournament play, are also included in the gaming application. As applied to Liar's Poker, prevention of cheating by collaboration of players to maximize the odds of winning may be accomplished through random session assignment at certain levels of play. The system may allow players to start a first session with friends, and even includes capability to invite friends to a session and chat during play. In certain game modes, however, players are assigned to random tables periodically, depending, for instance, on the win/loss record of the player, or another suitable factor, during the session. Identities at the random tables are concealed until after the game session is over. Accordingly, chat is not available during the randomized session. Players moved to a random game session may also be prevented from starting another game session with friends until the next calendar day.

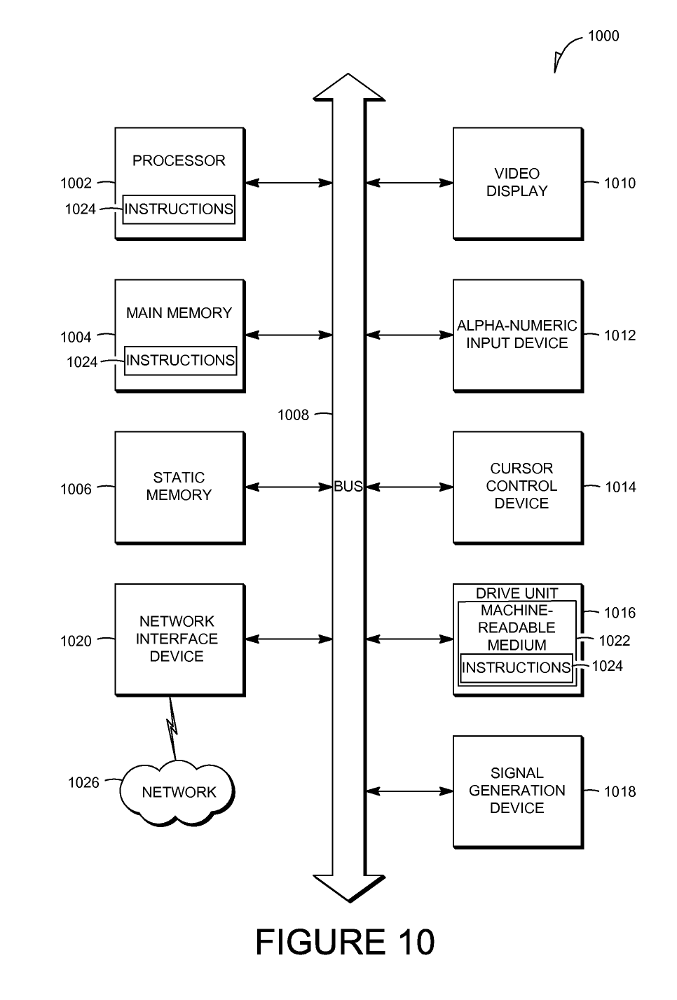

FIG. 10 shows a block diagram of a machine in the example form of a computer system 1000 within which a set of instructions may be executed causing the machine to perform any one or more of the methods, processes, operations, or methodologies discussed herein. The player device 102, the central gaming device 106, and/or the advertiser device 108 may include the functionality of the one or more computer systems 1000 (see FIG. 1).

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, a point of sale (POS) device, a cash register, an Automated Teller Machine (ATM), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a drive unit 1016, a signal generation device 1018 (e.g., a speaker) and a network interface device 1020.

The drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1012 during execution thereof by the computer system 1000, the main memory 1004 and the processor 1012 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the present invention. The term “machine-readable medium” shall accordingly be taken to include, but not be limited to, solid-state memories, and optical media, and magnetic media.

Certain systems, apparatus, applications or processes are described herein as including a number of modules. A module may be a unit of distinct functionality that may be presented in software, hardware, or combinations thereof. When the functionality of a module is performed in any part through software, the module includes a machine-readable medium. The modules may be regarded as being communicatively coupled.

In an example embodiment, execution of an executable application is initiated. The executable application is associated with source code of a gaming application and a compiled version of a gaming application. Advertising data is received through a network. The source code of the gaming application is recompiled using the advertising data to create a recompiled version of the gaming application. Game play of the recompiled version of the gaming application is initiated. The game play includes presentation of advertising based on at least a portion of the advertising data.

In an example embodiment, at least a first portion of source code of the gaming application is compiled using advertising data to create an executable file associated the gaming application. Game play of the gaming application is enabled using the executable file. The game play includes presentation of advertising based on at least a portion of the advertising data. Additional advertising data through a network is received. At least a second portion of the source code of the gaming application is compiled using the additional advertising data to create an additional executable file. Further game play of the gaming application is enabled using the additional executable file. The further game play includes presentation of additional advertising based on at least a portion of the additional advertising data.

In an example embodiment, execution of an executable application is initiated. The executable application is associated with source code of a gaming application and a compiled version of a gaming application. A source code key associated with the executable application is accessed. The source code is decrypted to obtain decrypted source code and an advertising data key. A determination that available advertising data associated with the gaming application is not valid by use of the advertising data key is performed. Replacement advertising data is received through a network. The source code of the gaming application is recompiled using the replacement advertising data to create a recompiled version of the gaming application. Game play of the recompiled version of the gaming application is initiated. The game play includes presentation of advertising based on at least a portion of the advertising data.

Thus, methods and systems for in-game advertising have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

Various activities described with respect to the methods identified herein can be executed in serial or parallel fashion. Although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A method comprising:
initiating execution of an executable application on the processor, the executable application associated with source code of a gaming application and a compiled version of a gaming application;
receiving advertising data on the processor through a network;
recompiling the source code of the gaming application on the processor using the advertising data to create a recompiled version of the gaming application; and
initiating game play of the recompiled version of the gaming application, the game play including presentation of advertising based on at least a portion of the advertising data.

2. The method of claim 1, further comprising:
decrypting the source code to obtain decrypted source code,
wherein recompiling source code of the gaming application is based on decryption of the source code.

3. The method of claim 2, further comprising:
accessing a source code key associated with the executable application,
wherein decrypting the source code includes decrypting the source code using the source code key to obtain the decrypted source code and recompiling the source code of the gaming application is based on decryption of the source code.

4. The method of claim 3, wherein decrypting the source code obtains the decrypted source code and an advertising data key, the method further comprising:
decrypting the advertising data using the advertising data key to obtain decrypted advertising data,
wherein recompiling the source code of the gaming application includes recompiling the source code of the gaming application on the processor using the decrypted advertising data to create the recompiled version of the gaming application.

5. The method of claim 1, further comprising:
identifying a hardware configuration associated with the processor,
wherein recompiling the source code is based on identification of the hardware configuration.

6. The method of claim 1, further comprising:
transmitting an advertisement request,
wherein the advertising data is received in response to transmission of the advertisement request.

7. The method of claim 6, wherein the advertisement request is transmitted by the executable application and the advertising data is received by the executable application.

8. The method of claim 1, further comprising:
receiving additional advertising data on the processor through a network;
recompiling the source code of the gaming application on the processor using the additional advertising data to create an additional recompiled version of the gaming application; and
initiating game play of the additional recompiled version of the gaming application.

9. The method of claim 1, further comprising:
receiving additional advertising data on the processor through a network;
recompiling the source code of the gaming application on the processor using the additional advertising data to create an additional recompiled version of the gaming application;
determining that recompilation of the source code was unsuccessful; and
initiating game play of the recompiled version of the gaming application.

10. The method of claim 1, wherein recompiling the source code comprises:
altering the source code of the gaming application to include the advertising data; and
compiling the altered source code to create the recompiled version of the gaming application.

11. The method of claim 10, wherein altering the source code comprises:
modifying a source code programming line of source code to include the advertising data.

12. The method of claim 11, further comprising:
identifying the source code programming line for inclusion of the advertising data,
wherein modification of the source code programming line is based on identification of the source code programming line.

13. The method of claim 1, further comprising:
formatting the advertising data for the gaming application to create formatted advertising data,
wherein recompiling the source code includes recompiling the source code of the gaming application on the processor using the formatted advertising data to create the recompiled version of the gaming application.

14. The method of claim 1, further comprising:
generating graphics for the gaming application based on the advertising data,
wherein recompilation of the source code includes recompiling the source code of the gaming application on the processor using the graphics to create the recompiled version of the gaming application.

15. The method of claim 1, further comprising:
modifying graphics associated with the gaming application based on the advertising data,
wherein recompilation of the source code includes recompiling the source code of the gaming application on the processor using the modified graphics to create the recompiled version of the gaming application.

16. The method of claim 1, further comprising:
verifying the recompiled version of the gaming application,
wherein initiation of the game play of the recompiled version of the gaming application is based on verification of the recompiled version of the gaming application.

17. The method of claim 1, further comprising:
generating a display including a game sequence during recompilation of the source code.

18. The method of claim 1, further comprising:
determining that the advertising data meets an advertising criterion associated with a player of the gaming application,
wherein initiation of the game play of the recompiled version of the gaming application is for the player of the gaming application.

19. The method of claim 18, further comprising:
receiving additional advertising data on the processor through a network;
determining that the additional advertising data meets the advertising criterion associated with an additional player of the gaming application,
recompiling the source code of the gaming application on the processor using the additional advertising data to create an additional recompiled version of the gaming application; and
initiating game play of the additional recompiled version of the gaming application for the additional play, the game play including presentation of advertising based on at least a portion of the additional advertising data.

20. The method of claim 19, wherein the game play of the player and the additional player occur simultaneously with the gaming application.

21. The method of claim 20, wherein the player and the additional player makes gaming interactions with one another during the game play.

22. The method of claim 1, further comprising:
operating the gaming application to enable a player to engage in the game play; and
crediting an account associated with the player based on the player engaged in the game play including the presentation of the advertising.

23. The method of claim 1, further comprising:
accessing registration data associated with a player of the gaming application;
selecting the advertising data from a plurality of available advertising data based on the registration data,
wherein initiation of the game play of the recompiled version of the gaming application is based on selection of the advertising data.

24. The method of claim 1, further comprising:
accessing player profile data associated with a player of the gaming application;
selecting the advertising data from a plurality of available advertising data based on the player profile data,
wherein initiation of the game play of the recompiled version of the gaming application is based on selection of the advertising data.

25. The method of claim 1, wherein the advertising is an image presented during the game play.

26. The method of claim 1, wherein the advertising data is received from an advertiser device.

27. The method of claim 1, wherein the advertising data is received from a central gaming device.

28. The method of claim 1, wherein the advertising is part of the image skin of the gaming application.

29. A method comprising:
compiling at least a first portion of source code of the gaming application on a processor using advertising data to create an executable file associated the gaming application;
enabling game play of the gaming application using the executable file, the game play including presentation of advertising based on at least a portion of the advertising data;
receiving additional advertising data on the processor through a network;
compiling at least a second portion of the source code of the gaming application on the processor using the additional advertising data to create an additional executable file; and
enabling further game play of the gaming application using the additional executable file, the further game play including presentation of additional advertising based on at least a portion of the additional advertising data.

30. The method of claim 29, further comprising:
determining that the additional advertising data has been received during the game play,
wherein compilation of at least the second portion of source code is in response to a determination that the additional advertising data has been received.

31. The method of claim 29, further comprising:
determining that a recompilation point has been reached during the game play,
wherein compiling at least the second portion of the source code of the gaming application is in response to a determination that the recompilation point has been reached.

32. The method of claim 29, wherein compiling at least the second portion of the source code occurs dynamically during game play.

33. A method comprising:
initiating execution of an executable application on a processor, the executable application associated with source code of a gaming application and a compiled version of a gaming application;
accessing a source code key associated with the executable application,
decrypting the source code to obtain decrypted source code and an advertising data key;
determining that available advertising data associated with the gaming application is not valid by use of the advertising data key;
receiving replacement advertising data on the processor through a network;
recompiling the source code of the gaming application on the processor using the replacement advertising data to create a recompiled version of the gaming application; and
initiating game play of the recompiled version of the gaming application, the game play including presentation of advertising based on at least a portion of the advertising data.

34. The method of claim 33, further comprising:
determining that the replacement advertising data associated with the gaming application is valid by use of the advertising data key,
wherein recompilation of the source code is based on a determination that the replacement advertising data is valid.
